(19) United States
(12) Patent Application Publication
(10) Pub. No.: US 2025/0295149 A1
(43) Pub. Date: Sep. 25, 2025

(54) Method for Producing Grain Mixture and Grain Mixture Produced by Means of Method

(71) Applicant: The Quaker Oats Company, Chicago, IL (US)

(72) Inventors: Jiajia Xue, Shanghai (CN); Lanxing Jia, Shanghai (CN); Aimin Yang, Shanghai (CN); Xiaohang Xia, Shanghai (CN); Tianyuan Lou, Shanghai (CN); Chenguang Yang, Shanghai (CN); Meiyuan Feng, Shanghai (CN); Xirui Zhou, Shanghai (CN); Feng Liu, Shanghai (CN)

(21) Appl. No.: 18/861,836

(22) PCT Filed: May 5, 2023
(86) PCT No.: PCT/CN2023/092260

§ 371 Date: Jun. 17, 2025

(30) Foreign Application Priority Data
May 5, 2022 (CN) 202210482108.3

(51) Int. Cl. A23L 7/143; A23L 7/10; A23L 7/135; A23L 33/15; A23L 33/16

(52) U.S. Cl. CPC A23L 7/143; A23L 7/101; A23L 7/115; A23L 7/135; A23L 33/15; A23L 33/16

(57) ABSTRACT

A method for producing a grain mixture, comprising: by weight, mixing 50% to 89% of a grain fiber source, 10% to 50% of an inorganic salt, 1% to 10% of a vitamin and a derivative compound thereof or a mixture of the two, and 0% to 1% of other auxiliary materials to form a starting mixture; mixing the starting mixture with water to generate dough; performing extrusion molding; and drying till the water content is 1%-5% by weight. A high fiber product and an oat product containing the grain mixture are also disclosed.

### CROSS-REFERENCE TO RELATED APPLICATIONS

This application claims priority to Chinese Patent Application No. 202210482108.3, entitled “METHOD FOR PRODUCING GRAIN MIXTURE AND GRAIN MIXTURE PRODUCED BY MEANS OF METHOD”, filed on May 5, 2022, the content of which is incorporated herein by reference in its entirety.

### TECHNICAL FIELD

The present disclosure relates to a method for producing a grain mixture, particularly relates a method for producing a grain mixture that can be used for nutritional enrichment, and a grain mixture produced by the method.

### BACKGROUND

With today's busy lifestyle, consumers need nutritional supplements that are convenient and rich in nutrients to keep healthy, such as vitamin tablets, glucose oral solution, and grain products, which serve as an auxiliary means of diet to supplement various nutrients needed by the human body. Researches have shown that grain products can help reduce the risk of diseases, such as high cholesterol, heart disease, and obesity, thus attracting increasing attention from consumers. However, according to the Chinese Dietary Guidelines, the average intake of whole grain (in terms of coarse grains and mixed beans, except rice and flour) for Chinese adults is 14.2 grams per day, less than one third of the recommended minimum of 50 grams (whole grains and mixed beans). Therefore, a nutritious and convenient grain product is needed for people.

Extrusion cooking, which is a continuous cooking, mixing and molding process, is a common and highly efficient technology in food processing, and it is increasingly used in the production of grain products, wherein, an extrusion-expansion machine integrating multiple unit operations such as conveying, mixing, heating, extrusion, and shearing is used as a reactor for grain production. Currently, extrusion cooking has become a major processing method for processing dietary fiber in the food developed countries of the world. However, there is still a long-term problem about how to improve the processing technology to enhance the edibility and mouthfeel of different foods.

### SUMMARY

Accordingly, the present disclosure provides a method for producing a grain mixture and a product thereof.

In one aspect, the present disclosure provides a method for producing a grain mixture, including:
mixing 50% to 89% by weight of one or more grain fiber sources; 10% to 50% by weight one or more inorganic salts; 1% to 10% by weight of one or more vitamins, one or more vitamin-derived compounds, or a mixture of the two; and 0% to 1% by weight of one or more other auxiliary materials to form a starting mixture;
mixing the starting mixture with water to form a dough; extruding the dough through a die surface using a multi-zone extruder to form a molded grain mixture; and
drying the molded grain mixture until having a water content of 1% to 5% by weight,
wherein the molded grain mixture has a soft and glutinous texture with a soft core after the molded grain mixture has been mixed with water at a temperature above 90° C. for 3 to 5 minutes.

In another aspect, the present disclosure provides a grain mixture produced by the aforementioned method.

In still another aspect, the present disclosure provides a high fiber product, including an edible fiber source and the aforementioned grain mixture.

In yet another aspect, the present disclosure further provides an oat product, including 92% to 99% by weight of an instant oatmeal and 1% to 8% by weight of the aforementioned grain mixture.

In yet another aspect, the present disclosure further provides an oat product, including 96% to 98% by weight of an instant oatmeal and 2% to 4% by weight of the aforementioned grain mixture.

### BRIEF DESCRIPTION OF THE DRAWINGS

In the following description, the embodiments of the present disclosure will be described with reference to the following accompanying drawings.

FIG. 1 is an image of a grain mixture tablet produced according to an embodiment of the present disclosure.

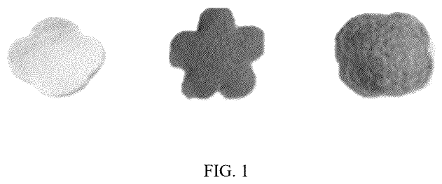

### DETAILED DESCRIPTION OF THE EMBODIMENTS

The present disclosure will be described in further detail below so that those skilled in the art to which the present disclosure belongs can easily put the present disclosure into practice. However, it should be understood that the present disclosure may be embodied in various forms and is not limited to the specific embodiments described herein, and that the embodiments of the present disclosure are merely illustrations.

As used herein, the term “about” or “approximately” as applied to numerical values encompasses the exact value and a reasonable variance.

Unless otherwise specified, the terms “comprise” and “include”, and grammatical variants thereof, are intended to represent “open” or “inclusive” language such that they include recited elements but also permit inclusion of additional, unrecited elements.

As used herein, the term “and/or” includes one or more related or any combination thereof of the items listed.

Unless otherwise specified, all percentages in the present specification refer to the weight percentage. The expressions “be present in an amount of . . . % by weight of”, “weight %”, “% by weight”, and “wt. %” are synonyms and refer to an amount expressed in percentage based on dry weight.

The term “water activity” (Aw) is defined as the active part of the water content or free water in the substance. Water activity is a common parameter in the food industry. It is an important parameter for food product design and food safety, and has significant effect on food nutrition, color, flavor, texture, and food preservation.

Unless otherwise defined, all terms have and should be assigned the same meanings as commonly understood by those skilled in the art to which the present disclosure belongs.

In one aspect, the present disclosure provides a method for producing a grain mixture, including: mixing 50% to 89% by weight of one or more grain fiber sources; 10% to 50% by weight of one or more inorganic salts; 1% to 10% by weight of one or more vitamins, one or more vitamin-derived compounds, or a mixture of the two; and 0% to 1% by weight of one or more other auxiliary materials to form a starting mixture; mixing the starting mixture with water to form a dough; extruding the dough through a die surface using a multi-zone extruder to form a molded grain mixture; and drying the molded grain mixture until having a water content of 1% to 5% by weight. Wherein, the molded grain mixture has a soft and glutinous texture with a soft core after the molded grain mixture has been mixed with water at a temperature above 90° C. for 3 to 5 minutes.

The starting mixture can be a mixture including grains and any other components suitable for consumption by mammals. In some embodiments, the starting mixture can include only one or more grain fiber sources, such as corn fiber and oat fiber. In other embodiments, the starting mixture can include one or more grain fiber sources and one or more inorganic salts. In other embodiments, the starting mixture can include: one or more grain fiber sources; one or more inorganic salts; one or more vitamins, one or more vitamin-derived compounds, or mixtures of the two, and one or more other auxiliary materials. The form of the starting mixture is not particularly limited and can be adjusted as required, including but not limited to powder, tablet, suspension, granule, solution, capsule, pill, film, and the like. In some embodiments, the starting mixture is a powder.

Any suitable grain fiber sources can be used in the starting mixture of the present disclosure. In some embodiments, the grain fiber source is insoluble and/or soluble fibers. For example, the grain fiber source can include but not limited to corn fiber, oat fiber, wheat bran, oat bran, corn bran, corn flour, oat flour, wheat flour, whole wheat flour, and mixtures thereof. In a preferred embodiment, the grain mixture of the present disclosure is whole wheat flour. During milling, a whole grain of wheat is only ground without the bran removal procedure, wherein the whole grain of wheat, including the bran and the germ, all ground into flour, which is called whole wheat flour. In the past, the bran of wheat was not valued, so it was often used as feed. Several researches have now shown that the bran of wheat contains highly nutritious cellulose, which is, such as, often mixed into flour to make whole wheat bread for consumed by a large number of consumers, which can keep the human body healthy and active.

The proportion of the grain fiber source in the starting mixture affects the quality of the finished product, and also affects the performance of the extrusion cooking process. Therefore, it is particularly important to select a proper proportion of the grain fiber source. In one embodiment, the grain fiber source is present in an amount of about 50% to about 89% by weight of the starting mixture. In another embodiment, the grain fiber source is present in an amount of about 60% to about 75% by weight of the starting mixture. In still another embodiment, the grain fiber source is present in an amount of about 64% to about 70% by weight of the starting mixture.

Generally, in an extrusion process for grain, an inorganic salt is added to improve extrusion performance of the grain, which enables the grain mixture to form an expanded porous structure under certain conditions, thereby improving the homogeneity of the grain mixture. The microstructure of the grain mixture added with inorganic salts (such as calcium carbonate) shows fine texture with many pores and thin pore walls. Different proportions of the inorganic salt can form grain mixtures with different structures, which in turn changes processing conditions in the production process. In the present disclosure, the inorganic salt may be inorganic salt commonly used in grain products that are suitable for addition to food. In some embodiments, the inorganic salt can be halides, oxides, sulphates or other inorganic salts. In some embodiments, the inorganic salt can include but not limited to calcium chloride, calcium carbonate, calcium lactate, calcium bicarbonate, calcium silicate, calcium sulfate, sodium chloride, sodium carbonate, sodium bicarbonate, sodium sulfate, zinc sulfate, magnesium chloride, magnesium carbonate, magnesium silicate, magnesium sulfate, calcium citrate, zinc oxide, ferric pyrophosphate, and any mixture thereof. In a preferred embodiment, the inorganic salt is a calcium-containing inorganic salt, preferably calcium carbonate, calcium citrate, and calcium gluconate, most preferably calcium carbonate.

Calcium carbonate, calcium bicarbonate, and calcium silicate and etc., are expanding agents commonly used in grains. To achieve a good expansion effect, the proportion of calcium carbonate used in grain products is generally less than or equal to 2.5 wt. %, for example, about 0.2 wt. % to about 0.4 wt. %. If the amount is too small, it cannot achieve a good expansion effect. The present applicant has found that when the amount of calcium carbonate in the grain mixture increases to a certain proportion, expansion is suppressed, resulting in a grain mixture with soft, glutinous, and chewable texture. By increasing the amount of calcium carbonate, a product with soft, glutinous, and chewable texture that is different from a thin and crisp mouthfeel in the prior art is obtained. The product is rich in nutrients such as fiber and vitamins, and can be used as a nutritional supplement or a part of diet, especially for the elderly and children, which can increase adaptability and interest in eating. However, when the content of calcium carbonate continuously increases to a certain percentage, it may also bring a hard texture and mouthfeel.

Therefore, in some embodiments of the present disclosure, calcium carbonate is present in an amount of about 10% to about 50% by weight of the starting mixture. In other embodiments, calcium carbonate is present in an amount of about 17% to about 32% by weight of the starting mixture. In some preferred embodiments, calcium carbonate is present in an amount of about 23% to about 29% by weight of the starting mixture. In one of the most preferred embodiments, calcium carbonate is present in an amount of about 23.55% by weight of the starting mixture.

The addition amount of the expanding agent is generally about 0.2 wt. % to about 2.5 wt. % of the total mixture. The applicant has found that expansion can be suppressed when the amount of calcium carbonate increases to a certain proportion.

A vitamin, a vitamin-derived compound, or a mixture thereof can be added to the starting mixture to increase the overall nutrition of the grain mixture. Vitamins commonly used in food include vitamin B1, vitamin B2, vitamin B3, vitamin B4, vitamin B5, nicotinamide, vitamin B6, vitamin B12, vitamin H, vitamin C, vitamin A, vitamin D, vitamin E, and vitamin K, etc. In one embodiment, the vitamin can be a mixture of vitamin A, vitamin C, vitamin D, vitamin B, and vitamin E. In another embodiment, the vitamin can be a mixture of vitamin B6, vitamin E, and vitamin C. In still another embodiment, the vitamin can be a mixture of vitamin D and vitamin E.

The amount of one or more vitamins, one or more vitamin-derived compounds, or mixtures thereof can be adjusted, such that the vitamin is present in a suitable amount in the final grain mixture. In some embodiments, the vitamin, the vitamin-derived compound, or the mixture thereof can be present in an amount of about 1% by weight of the starting mixture. In some embodiments, the vitamin, the vitamin-derived compound, or the mixture thereof is present in an amount of about 1% to about 10% by weight of the starting mixture. In other embodiments, the vitamin, the vitamin-derived compound, or the mixture thereof is present in an amount of about 4% to about 8% by weight of the starting mixture. In a preferred embodiment of the present disclosure, the vitamin, the vitamin-derived compound, or the mixture thereof can be present in an amount of about 5% to about 7% by weight of the starting mixture. In a most preferred embodiment, the vitamin, the vitamin-derived compound, or the mixture thereof can be present in an amount of about 6% by weight of the starting mixture.

When forming the starting mixture, one or more vitamins, one or more vitamin-derived compounds, or a mixture of the two can be added directly to the starting mixture. However, in other embodiments, one or more vitamins, one or more vitamin-derived compounds, or a mixture of the two can be first mixed to form a vitamin premix, which is then added to the starting mixture. In some embodiments, the vitamin premix can further include other additives except vitamins, vitamin-derived compounds, or mixtures of the two. For example, the vitamin premix can further include but is not limited to grain fiber sources, inorganic salts, carbohydrate sources, nitrogen source proteins, amino acids, saturated or unsaturated fatty acids, plant extracts, sterols, colorants, fragrances, preservatives, thickeners, fillers, and the like. In some embodiments, the vitamin premix can further include maltodextrin and β-carotene. The purpose of pre-mixing is to make the starting mixture more evenly mixed. The vitamin premix can be configured as required voluntarily or purchased from a commercial product.

The grain mixture can further include other auxiliary materials, for example, one or more additives, including but not limited to nitrogen source proteins, amino acids, carbohydrate sources, saturated or unsaturated fatty acids, plant extracts, sterols, colorants, fragrances, preservatives, thickeners, fillers, flavoring agents, defoaming agents, fruit flakes, and other additives. In some embodiments, the grain mixture in the present disclosure can include colorants, fragrances, fillers, thickeners, and the like. In some embodiments, the grain mixture can include maltodextrin and β-carotene. In some embodiments, the grain mixture can include curcumin or other functional raw materials such as DHA powder, phytosterol esters, phosphatidylserine, mulberry leaf extracts, and the like.

The weight ratio of other auxiliary materials in the starting mixture is generally about 0% to about 1%. In some embodiments, the weight ratio of other auxiliary materials in the starting mixture is about 0.2% to about 0.6%.

In the production method of the present disclosure, the starting mixture can be mixed using any suitable methods and devices known in the art. For example, in some embodiments, the starting mixture can be evenly mixed using a horizontal high-speed mixer. The mixing speed, mixing time and mixing weight can be adjusted by those skilled in the art as required.

The evenly mixed starting mixture can be directly fed to the feed port of the extruder by a screw feeder, or can be pretreated before feeding to the extruder, for example, pretreated using a modulator. In some embodiments, the evenly mixed starting mixture can be directly fed to the feed port of the extruder by a screw feeder. In other embodiments, the evenly mixed starting mixture can be pretreated using a modulator before feeding to the extruder. For example, the starting mixture can be modulated in a modulator with liquid water, steam water, oil, or the like, and then fed to the extruder.

Water is injected into the modulator or the extruder by devices known in the art such as peristaltic pumps, injection plunger pumps, metering pumps, screw pumps, rotor pumps, and the like. The sequence of adding the starting mixture and water is not specifically limited, but a ratio of the starting mixture to water can be adjusted as required, as long as the starting mixture and water can form a dough. For example, in some embodiments, a feed amount of the starting mixture is about 80 kg/h to about 125 kg/h and an injection amount of water is about 4.5 kg/h to about 9.0 kg/h. Dough is formed when the starting mixture is properly mixed with water.

The extruder includes a single screw or a twin-screw extruder, as well as a rare multi-screw extruder and a screwless extruder. The screw extruder relies on the pressure and shear force generated by the rotation of screw, to fully plasticize and evenly mix the material and then mold it through a die surface. Any suitable extruders can be used, for example, a twin-screw extruder including multiple heating zones. The number of heating zones can be adjusted as required. For example, the extruder can have 4, 5, 6, 7, 8 and more heating zones. In some embodiments, an extruder with four heating zones is used. In addition, a temperature of heating zones can also be adjusted as required. In a grain extrusion cooking process, the temperature of heating zones is generally 60° C. to 160° C., generally a relatively high temperature, so as to produce an expanded and high-temperature sterilized grain product. However, by increasing the proportion of calcium carbonate, a grain mixture with soft, glutinous, and chewable texture that is different from the thin and crisp mouthfeel in the prior art, is prepared by the applicant. The grain mixture with soft, glutinous, and chewable texture does not require an excessive heating temperature. Therefore, in some embodiments of the present disclosure, the heating temperature of heating zones is 50° C. to 130° C. In some embodiments of the present disclosure, the multi-zone extruder includes four heating zones: a first zone, a second zone, a third zone, and a fourth zone. A temperature of the first zone is 50° C. to 90° C., a temperature of the second zone is 60° C. to 110° C., a temperature of the third zone is 70° C. to 120° C., and a temperature of the fourth zone is 80° C. to 130° C. The dough is subjected to the four heating zones. In addition, a heating time of the dough can also be adjusted as required.

The inventors of the present disclosure have found that the grain mixture of the present disclosure can be produced at a lower temperature of high-temperature sterilization than the prior art. In addition, by increasing the proportion of calcium carbonate and reducing the proportion of the grain fiber, a shear force and a process temperature can be reduced, which makes the production method an environment-friendly and cost-saving method.

In some embodiments of the present disclosure, a processing time of the first zone is 6 to 40 seconds, a processing time of the second zone is 5 to 30 seconds, a processing time of the third zone is 5 to 30 seconds, and a processing time of the fourth zone is 4 to 20 seconds. After the heating is completed, the dough is extruded through the die surface to form a molded grain mixture. As is known in the art, the die surface can have any suitable shape, for example, includes but is not limited to a circular shape, a square shape, a rectangle shape, a star shape, a love shape, a diamond shape, and a clover shape.

The extruded grain mixture includes a certain amount of water, and the grain mixture is usually dried to remove excess water for easy preservation and storage. Water content is a weight proportion of water in the grain mixture. Generally, the molded grain mixture is dried until the water content is about 1 wt. % to about 10 wt. %, preferably about 1 wt. % to about 8 wt. %, more preferably about 1 wt. % to about 5 wt. %, and most preferably about 3 wt. % to about 5 wt. %. The extruded grain mixture can be directly dried, or can be properly treated, for example, reducing its volume, and then dried. Reducing the volume of the extrudate allows for faster and more evenly drying, facilitating storage and further processing. The extruded grain mixture can be cut into blocks, flakes, and the like using a cutting tool. In some embodiments, the extruded grain mixture is cut into flakes to shorten the drying time and reduce the drying temperature. In some embodiments, the drying temperature is about 0° C. to about 120° C., and the drying time is about 25 to about 100 minutes. In some embodiments, the water activity after drying is measured to be less than or equal to 0.5, according to the second method in the National Food Safety Standard-Determination of water activity in foods (GB 5009.238-2016).

In another aspect of the present disclosure, a grain mixture produced according to the aforementioned method is provided.

In some embodiments, the grain mixture can include: one or more grain fiber sources, one or more inorganic salts, one or more vitamins, one or more vitamin-derived compounds, or mixtures of the two, and one or more other auxiliary materials. In some embodiments, the grain mixture can include whole wheat flour, calcium carbonate, vitamin E, vitamin B6, vitamin C, vitamin E, and zinc oxide. In some embodiments, the grain mixture can include whole wheat flour, calcium carbonate, vitamin D, and vitamin E.

In some embodiments, the water content of the molded grain mixture is about 1 wt. % to about 10 wt. %, preferably about 1 wt. % to about 8 wt. %, more preferably about 1 wt. % to about 5 wt. %, and most preferably about 3 wt. % to about 5 wt. %.

In some embodiments, the molded grain mixture has a soft and glutinous texture with a soft core after it has been mixed with water at a temperature above 90° C. for 3 to 5 minutes. The mixing time is not specifically limited, but is preferably about 3 to about 4 minutes, more preferably about 3 minutes. In some embodiments, water above 90° C. can be directly mixed with the grain mixture. In other embodiments, the temperature of the water may not be limited, but the ambient temperature is set to be above 90° C., for example, by heating.

The grain mixture can be used alone as a preparation, for example, as a nutritional supplement, such as a vitamin supplement or a fiber supplement. In addition, the grain mixture can be used in any suitable foods for drinking, such as food and beverages, such as cereal, rice, snack, fruit, and juice. Adding the grain mixture can enrich the mouthfeel and increase the interest in eating. Therefore, in yet another aspect of the present disclosure, a high fiber product is provided, including an edible fiber source and the aforementioned grain mixture.

The edible fiber source is a plant complex including fruits, vegetables, and grains, which plays an important role in human health.

In some embodiments, the high fiber product can include about 92% to about 99% by weight of the edible fiber source and about 1% to about 8% by weight of the grain mixture. In some embodiments, the high fiber product can include about 96% to about 98% by weight of the edible fiber source and about 2% to about 4% by weight of the grain mixture. In a preferred embodiment, the high fiber product can include about 96% to about 97.2% by weight of the edible fiber source and about 2.8% to about 4% by weight of the grain mixture. In addition, based on Dietary Nutrition Guidelines and related data, 30% of daily nutrient intake can be provided by only adding about 2.8% to about 4% by weight of a grain mixture to a high fiber product (calculated according to the Nutrient Reference Values (NRV) for food labels in the General Rules for the Nutrition Label of Prepackaged Food (GB 28050-2011))

In some embodiments, the high fiber product can include oats and the aforementioned grain mixtures. Therefore, the high fiber product is rich in nutrients, particularly suitable for the elderly and children to consume. In the prior art, a high fiber product generally has a thin and crisp mouthfeel and is easy to become soft after brewing, resulting in a bad consumer experience. However, the high fiber product obtained according to the present disclosure has a novel, soft, glutinous, and chewable mouthfeel.

In some embodiments, the aforementioned high fiber product is an oat product. In some preferred embodiments, the oats are instant oatmeal. In some preferred embodiments, the oat product includes 92% to 99% by weight of the instant oatmeal and 1% to 8% by weight of the grain mixture of the present disclosure. In some preferred embodiments, the oat product includes 96% to 98% by weight of the instant oatmeal and 2% to 4% by weight of the grain mixture of the present disclosure.

### EXAMPLE

Unless otherwise specified, the whole wheat flour used in the following examples is purchased from China Oil and Foodstuffs Corporation, and the vitamin premix is purchased from DSM Vitamin (Shanghai) Co., Ltd., common chemicals such as calcium carbonate are food grade and commercially available products.

### Example 1. Preparation of Grain Mixtures with Increased Calcium Carbonate Content

In this example, grain mixture tablets with increased calcium carbonate content were prepared by the aforementioned method of the present disclosure, and brewing tests of the grain mixture tablets were performed.

The preparation method was as follows. Whole wheat flour, calcium carbonate, and vitamin compounds were added and mixed in a horizontal high-speed mixer, according to the component Formula 1 to 4 of the starting mixture in Table 1 below, wherein a mixing speed was 75 to 150 rpm and a mixing time was 5 to 15 min. A powder mixture was then formed. The evenly mixed powder mixture was fed to a twin-screw extruder through a screw feeder, and water was injected through a peristaltic pump. A feed amount of the powder mixture was 80 to 125 kg/h, and an inject amount of water was 4.5 to 9.0 kg/h. After the powder mixture was stirred with water in the extruder, a dough was formed. The dough was subjected to four heating zones: a first zone, a second zone, a third zone, and a fourth zone. A temperature of the first zone was 50° C. to 90° C., a temperature of the second zone was 60° C. to 110° C., a temperature of the third zone was 70° C. to 120° C., and a temperature of the fourth zone was 80° C. to 130° C. A processing time of the first zone was 6 to 40 seconds, a processing time of the second zone was 5 to 30 seconds, a processing time of the third zone was 5 to 30 seconds, and a processing time of the fourth zone was 4 to 20 seconds. Then, the heated dough was extruded through a die surface to form a molded grain mixture, which was cut into flakes with a bulk density of 270 to 400 g/L using a cutter. A main screw speed of the extruder was 150 to 300 rpm, and a die surface pressure was 15 to 80 bar. Thereafter, the flakes were dried in a fluidized shaking bed at 70 to 120° C. for 1 to 10 minutes, and then transferred into an oven for further drying at a temperature of 75 to 120° C. for 25 to 90 minutes, until the water content was 3 wt. % to 5 wt. %, and finally the dried grain mixture tablets were obtained.

Brewing tests of the grain mixture tablets were performed as follows. The prepared grain mixture tablets of Formula 1 to 4 were brewed with hot water above 90° C. for about 3 to about 5 minutes, and then tested for softness and mouthfeel by at least 5 tasters.

TABLE 1
Formula of starting mixture for grain mixture tablets with increased calcium carbonate
content and results of brew tests for corresponding grain mixture tablets

| | Components of starting mixture for grain mixture and | | | | |
|---|---|---|---|---|---|
| | content thereof (wt. %) | | | | |
| | | | Mixed | | |
| | Whole | | tocopherol | | Result of brew |
| | wheat | Calcium | concentrate | Cholecalciferol | test for grain |
| | flour | carbonate | (Vitamin E) | (Vitamin D) | mixture tablets |
| Formula | 83.9 | 16 | 0.042 | 0.058 | tended to become soft, |
| 1 | | | | | fluffy texture |
| Formula | 70.91 | 29 | 0.042 | 0.048 | no hard core, soft and |
| 2 | | | | | glutinous mouthfeel, |
| | | | | | chewable texture |
| Formula | 68.9 | 31 | 0.042 | 0.058 | no hard core, soft and |
| 3 | | | | | glutinous mouthfeel, |
| | | | | | chewable texture |
| Formula | 66.9 | 33 | 0.042 | 0.058 | had hard core, raw |
| 4 | | | | | mouthfeel, unchewable |
| | | | | | texture |

*The percentage of each component (wt. %) is the weight percentage of each component in the powder mixture at the time of initial mixing.

As a result, after brewing with hot water, the grain mixture tablets of Formula 1 (calcium carbonate content: 16%) exhibited a fluffy texture and tended to become soft, having a poor mouthfeel, while the grain mixture tablets with increased calcium carbonate contents (29% and 31%, Formula 2 and Formula 3) had a relatively soft and glutinous mouthfeel, and presented a chewable texture, having a good mouthfeel. However, when the content of calcium carbonate increased to a certain degree (33%, Formula 4), the grain mixture tablet had a hard core after brewing, and presented a raw and unchewable texture, having a poor mouthfeel.

### Example 2. Preparation of Grain Mixtures Rich in Vitamin and with Increased Calcium Carbonate Content

In this example, tablets with increased calcium carbonate content were prepared by the same method as in Example 1. The specific formula of the starting mixture used is shown in Table 2 below.

TABLE 2
Formula of starting mixture for grain mixture tablets
with increased calcium carbonate content

| | | Percentage | Weight |
|---|---|---|---|
| | Component | (wt. %) | (kg) |
| Formula 5 | Whole wheat flour | 70 | 350 |
| | Vitamin premix (Vitamin A (Vitamin A | 6 | 30 |
| | palmitate), Vitamin D3, tocopherol | | |
| | equivalent (Vitamin E), pyridoxine | | |
| | (Vitamin B6), Vitamin C (L-ascorbic | | |
| | acid), iron (ferric pyrophosphate), | | |
| | maltodextrin) | | |
| | β-carotene BC YELLOW 10CPWS | 0.4 | 2 |
| | Vitamin E | 0.05 | 0.25 |
| | Calcium carbonate | 23.55 | 117.75 |
| Total | | 100.00 | 500 |
| Formula 6 | Whole wheat flour | 64.55 | 193.65 |
| | Vitamin premix (Vitamin A (Vitamin A | 6 | 18 |
| | palmitate), Vitamin D3, tocopherol | | |
| | equivalent (Vitamin E), pyridoxine | | |
| | (Vitamin B6), Vitamin C (L-ascorbic | | |
| | acid), iron (ferric pyrophosphate), | | |
| | maltodextrin) | | |
| | β-carotene BC YELLOW 10CPWS | 0.4 | 1.2 |
| | Vitamin E | 0.05 | 0.15 |
| | Calcium carbonate | 29 | 87 |
| Total | | 100.00 | 300 |
| Formula 7 | Whole wheat flour | 69.84 | 349.2 |
| | Vitamin premix(Vitamin A (Vitamin A | 6 | 30 |
| | palmitate), Vitamin D3, tocopherol | | |
| | equivalent (Vitamin E), pyridoxine | | |
| | (Vitamin B6), Vitamin C (L-ascorbic | | |
| | acid), zinc (zinc oxide), maltodextrin) | | |
| | β-carotene BC YELLOW 10CPWS | 0.56 | 2.8 |
| | Mixed tocopherol concentrate (Vitamin | 0.05 | 0.25 |
| | E) | | |
| | Calcium carbonate | 23.55 | 117.75 |
| Total | | 100.00 | 300 |

*The percentage of each component (wt. %) is the weight percentage of each component in the powder mixture at the time of initial mixing.

Brewing tests of the grain mixture tablets were performed as follows. The prepared grain mixture tablets of Formula 5 to 7 were brewed with hot water above 90° C. for about 3 to about 5 minutes, and then tested for softness and mouthfeel by at least 5 tasters.

As a result, after brewing with hot water, the grain mixture tablets of Formula 5 to 7 were soft and glutinous, free of hard core, having a good mouthfeel. The grain mixture tablet of Formula 6 was chewable after brewing with hot water, but had a slightly harder mouthfeel than Formula 5 and Formula 7.

In addition, the shelf-life loss test was performed on Formula 7. The grain mixture tablet of Formula 7 was stored at room temperature for 3 months under a packaging condition of PE bag and kraft paper bag, and the vitamin content before and after storage were detected. As a result, the 3-month loss of vitamin A and vitamin D was 36% and 11%, respectively.

### Example 3. Preparation of an Improved Grain Mixture

A grain mixture tablet was prepared by the same method as in Example 1, and Formula 7 in Example 2 was improved to obtain Formula 8. The specific formula is shown in Table 3 below.

TABLE 3
Formula of starting mixture for grain mixture tablets
with increased calcium carbonate content

| | | Percentage | Weight |
|---|---|---|---|
| | Component | (wt. %) | (kg) |
| Formula 8 | Whole wheat flour | 69.84 | 349.2 |
| | Vitamin premix (Tocopherol equivalent | 6 | 30 |
| | (Vitamin E), pyridoxine (Vitamin B6), | | |
| | Vitamin C (L-ascorbic acid), zinc (zinc | | |
| | oxide), maltodextrin) | | |
| | β-carotene BC YELLOW 10CPWS | 0.56 | 2.8 |
| | Mixed tocopherol concentrate (Vitamin | 0.05 | 0.25 |
| | E) | | |
| | Calcium carbonate | 23.55 | 117.75 |
| Total | | 100.00 | 300 |

*The percentage of each component (wt. %) is the weight percentage of each component in the powder mixture at the time of initial mixing.

A brewing test of the grain mixture tablet was performed as follows. The prepared grain mixture tablet of Formula 8 was brewed with hot water above 90° C. for about 3 to about 5 minutes, and then tested for softness and mouthfeel by at least 5 tasters.

As a result, after brewing with hot water, the grain mixture tablet of Formula 8 was soft and glutinous, free of hard core, having a good mouthfeel.

### Example 4. Nutrition Test of Oat Product Made from Grain Mixture Tablet

Nutritional tests were performed on an oat product made from the grain mixture tablet obtained from Formula 8 in Example 3.

Nutrient reference value (NRV) is an abbreviation of “nutrient reference value for Chinese food labels”, which is a reference standard dedicated to food labels for comparing the nutrient content of food, and is a nutrition reference standard for consumer when choosing food. The NRV is determined mainly based on the recommended daily intake and appropriate intake of dietary nutrients for Chinese residents. The calculation formula is as follows:

$$Y \% = X / NRV \times 100 \% ,$$

Wherein, X refers to the content of a nutrient in food, NRV refers to the nutrient reference value of the nutrient, and Y % refers to the calculated result of nutrient reference value.

Nutrition tests on the components of the product were performed according to the national standard (GB) test method. The test methods and results are shown in Table 4 below.

TABLE 4
Nutritional test methods and results of
oat product containing grain mixture

| | | Nutrient reference |
|---|---|---|
| Main test item | Test method | value % |
| Energy | GB 28050 -2011 | 19% |
| Protein | GB 5009.5-2016, the first | 18% |
| | method | |
| Fats | GB 5009.6-2016, the second | 17% |
| | method | |
| Saturated fatty | GB 5009.168-2016, the first | 12% |
| acid | method | |
| Carbohydrate | GB 28050 -2011 | 19% |
| Dietary fiber | GB 5009.88-2014 | 44% |
| Sodium | GB/T 5009.91-2016, the third | 1% |
| | method | |
| Vitamin E | GB 5009.82-2016, the first | 30% |
| | method | |
| Vitamin B1 | GB5009.84-2016, the first | 16% |
| | method | |
| Vitamin B6 | GB 5009.154-2016, the first | 30% |
| | method | |
| Vitamin C | GB 5009.86-2016, the first | 15% |
| | method | |
| Magnesium | GB 5009.241-2017, the | 34% |
| | second method | |
| Calcium | GB/T 5009.92-2016, the | 15% |
| | second method | |
| Iron | GB 5009.90-2016, the second | 15% |
| | method | |
| Zinc | GB 5009.14-2017, the first | 30% |
| | method | |

As a result, the oat product made from the grain mixture tablet of Formula 8 had good nutrient reference values, according to the General Principles of Nutrition Labels for Prepackaged Food (GB 28050-2011).

### Comparative Example 1. Preparation of Grain Mixture with Calcium Carbonate Content of 1%

In this example, grain mixture tablets with calcium carbonate contents of 1% in the starting mixture were prepared by the same method as in Example 1 as a comparative example, and tests were performed. The formula is shown in Table 5 below.

TABLE 5
Formula of grain mixture tablets with
calcium carbonate contents of 1%

| | | Percentage | Weight |
|---|---|---|---|
| | Component | (wt. %) | (kg) |
| Formula 9 | Whole wheat flour | 93.75 | 281.25 |
| | vitamin premix (Vitamin A (Vitamin A | 5 | 15 |
| | palmitate), Vitamin D3, tocopherol | | |
| | equivalent (Vitamin E), pyridoxine | | |
| | (Vitamin B6), Vitamin C (L-ascorbic | | |
| | acid), zinc (zinc oxide), maltodextrin) | | |
| | Curcumin | 0.2 | 0.6 |
| | Vitamin E | 0.05 | 0.15 |
| | Calcium carbonate | 1 | 3 |
| Total | | 100.00 | 300 |
| Formula | Whole wheat flour | 60.82 | 182.46 |
| 10 | Phytosterol esters | 8.33 | 24.99 |
| | Oat β-glucan | 29.8 | 89.4 |
| | Vitamin E | 0.05 | 0.15 |
| | Calcium carbonate | 1 | 3 |
| Total | | 100.00 | 300 |
| Formula | Whole wheat flour | 94.064 | 282.192 |
| 11 | PS (phosphatidylserine) | 0.71 | 2.13 |
| | Zinc sulfate | 0.446 | 1.338 |
| | DHA | 3.73 | 11.19 |
| | Vitamin E | 0.05 | 0.15 |
| | Calcium carbonate | 1 | 3 |
| Total | | 100.00 | 300 |
| Formula | Whole wheat flour | 92.85 | 278.55 |
| 12 | Vitamin premix (Vitamin A (Vitamin A | 6 | 18 |
| | palmitate), Vitamin D3, tocopherol | | |
| | equivalent (Vitamin E), pyridoxine | | |
| | (Vitamin B6), Vitamin C (L-ascorbic | | |
| | acid), iron (ferric pyrophosphate), | | |
| | maltodextrin) | | |
| | β-carotene BC YELLOW 10CPWS | 0.1 | 0.3 |
| | Vitamin E | 0.05 | 0.15 |
| | Calcium carbonate | 1 | 3 |
| Total | | 100.00 | 300 |
| Formula | Whole wheat flour | 92.75 | 278.25 |
| 13 | Vitamin premix (Vitamin A (Vitamin A | 6 | 18 |
| | palmitate), Vitamin D3, tocopherol | | |
| | equivalent (Vitamin E), pyridoxine | | |
| | (Vitamin B6), Vitamin C (L-ascorbic | | |
| | acid), zinc (zinc oxide), maltodextrin) | | |
| | β-carotene BC YELLOW 10CPWS | 0.2 | 0.6 |
| | Vitamin E | 0.05 | 0.15 |
| | Calcium carbonate | 1 | 3 |
| Total | | 100.00 | 300 |
| Formula | Whole wheat flour | 50.55 | 151.65 |
| 14 | DHA powder | 12 | 36 |
| | β-carotene BC YELLOW 10CPWS | 0.4 | 1.2 |
| | Vitamin E | 0.05 | 0.15 |
| | β-cyclodextrin | 36 | 108 |
| | Calcium carbonate | 1 | 3 |
| Total | | 100.00 | 300 |

*The percentage of each component (wt. %) is the weight percentage of each component in the powder mixture at the time of initial mixing.

Brewing tests of the grain mixture tablets were performed as follows. The prepared grain mixture tablets of Formula 9 to 14 were brewed with hot water above 90° C. for about 3 to about 5 minutes, and then tested for softness and mouthfeel by at least 5 tasters.

As a result, after brewing with hot water, the grain mixture tablets of Formula 9 to 14 expanded rapidly and became soft, having a poor mouthfeel.

Each of the technical features of the aforementioned embodiments can be combined arbitrarily. To simplify the description, not all the possible combinations of the technical features in the aforementioned embodiments are described. However, all of the combinations of these technical features should be considered as within the scope of the present disclosure, as long as such combinations do not contradict with each other.

The aforementioned embodiments merely represent several embodiments of the present disclosure, and the description thereof is specific and detailed, but it should not be constructed as limiting the scope of the present disclosure. It should be noted that a plurality of variations and modifications may be made by those skilled in the art without departing from the conception of the present disclosure, which are all within the protection scope of the present disclosure. Therefore, the protection scope of the present disclosure shall be subject to the appended claims.

What is claimed is:

1. A method for producing a grain mixture, comprising:
mixing 50% to 89% by weight of one or more grain fiber sources; 10% to 50% by weight of one or more inorganic salts; 1% to 10% by weight of one or more vitamins, one or more vitamin-derived compounds, or a mixture of the two; and 0% to 1% by weight of one or more other auxiliary materials to form a starting mixture;
mixing the starting mixture with water to form a dough;
extruding the dough through a die surface using a multi-zone extruder to form a molded grain mixture; and
drying the molded grain mixture until having a water content of 1% to 5% by weight,
wherein the molded grain mixture has a soft and glutinous texture with a soft core after the molded grain mixture has been mixed with water at a temperature above 90° C. for 3 to 5 minutes.

2. The method of claim 1, wherein the grain fiber source is insoluble and/or soluble fiber and is selected from the group consisting of corn fiber, oat fiber, wheat bran, oat bran, corn bran, corn flour, oat flour, wheat flour, whole wheat flour, and any mixture thereof.

3. The method of claim 1 or 2, wherein the inorganic salt is selected from the group consisting of calcium chloride, calcium carbonate, calcium lactate, calcium bicarbonate, calcium silicate, calcium sulfate, sodium chloride, sodium carbonate, sodium bicarbonate, sodium sulfate, zinc sulfate, magnesium chloride, magnesium carbonate, magnesium silicate, magnesium sulfate, calcium citrate, zinc oxide, ferric pyrophosphate, and a mixture thereof.

4. The method of any one of claims 1 to 3, wherein the vitamin is selected from the group consisting of vitamin A, vitamin C, vitamin D, vitamin B, vitamin E, and a mixture thereof.

5. The method of any one of claims 1 to 4, wherein the other auxiliary materials are selected from the group consisting of one or more of nitrogen source proteins, amino acids, carbohydrate sources, saturated or unsaturated fatty acids, plant extracts and derivatives thereof, sterols, colorants, fragrances, preservatives, thickeners, and fillers.

6. The method of any one of claims 1 to 5, wherein the inorganic salt is calcium carbonate, and calcium carbonate is present in an amount of 17% to 32% by weight of the starting mixture.

7. The method of any one of claims 1 to 6, wherein the grain fiber source is whole wheat flour and is present in an amount of 60% to 75% by weight of the starting mixture.

8. The method of any one of claims 1 to 7, wherein the vitamin is a mixture of vitamin C, vitamin B6, and vitamin E, and vitamin C, vitamin B6, vitamin E, derivative compounds thereof, or a mixture of the two is present in an amount of 4% to 8% by weight of the starting mixture.

9. The method of any one of claims 1 to 8, wherein the multi-zone extruder comprises four heating zones: a first zone, a second zone, a third zone, and a fourth zone, a temperature of the first zone is 50° C. to 90° C., a temperature of the second zone is 60° C. to 110° C., a temperature of the third zone is 70° C. to 120° C., and a temperature of the fourth zone is 80° C. to 130° C.

10. The method of claim 9, wherein a processing time of the first zone is 6 to 40 seconds, a processing time of the second zone is 5 to 30 seconds, a processing time of the third zone is 5 to 30 seconds, and a processing time of the fourth zone is 4 to 20 seconds.

11. The method of any one of claims 1 to 10, wherein a drying temperature is 70° C. to 120° C., a drying time is 25 to 100 minutes, and a water activity after drying is less than or equal to 0.5.

12. The method of any one of claims 1 to 11, wherein the molded grain mixture is dried until having a water content of 3% to 5% by weight.

13. A grain mixture produced according to the method of any one of claims 1 to 12.

14. A high fiber product, comprising an edible fiber source and the grain mixture of claim 13.

15. An oat product, comprising 92% to 99% by weight of an instant oatmeal and 1% to 8% by weight of the grain mixture of claim 13.

16. An oat product, comprising 96% to 98% by weight of an instant oatmeal and 2% to 4% by weight of the grain mixture of claim 13.
